(19) United States
(12) Patent Application Publication
(10) Pub. No.: US 2019/0160875 A1
(43) Pub. Date: May 30, 2019

(54) PNEUMATIC TIRE

(71) Applicant: Toyo Tire & Rubber Co., Ltd., Itami-shi (JP)

(72) Inventor: Seiji Yokomakura, Itami-shi (JP)

(73) Assignee: Toyo Tire & Rubber Co., Ltd., Itami-shi (JP)

(21) Appl. No.: 16/183,015

(22) Filed: Nov. 7, 2018

(30) Foreign Application Priority Data
Nov. 28, 2017 (JP) 2017-228119

(51) Int. Cl. B60C 11/01; B60C 11/03

(52) U.S. Cl. CPC B60C 11/01; B60C 2011/013; B60C 11/032

(57) ABSTRACT

A pneumatic tire includes a tread portion, a side wall portion, a buttress portion provided between the tread portion and the side wall portion, a recessed groove provided in the buttress portion and extending along a tire circumferential direction and small hole lines provided in a tire width direction inner side of a contact ground end in the tread portion, in which the small hole lines have a plurality of small holes provided at intervals along the tire circumferential direction, and the small holes communicate with the recessed groove.

### BACKGROUND OF THE INVENTION

### 1. Field of the Invention

The present invention relates to a pneumatic tire.

### 2. Description of Related Art

In a pneumatic tire, a ground contact pressure is normally increased in the vicinity of a ground contact end of a tread portion during travelling, therefore, uneven wear in which a wear amount in the vicinity of the ground contact end is larger than that in other parts may occur.

Also in the pneumatic tire, heat generation is high at a belt end during travelling, therefore, generated heat is not easily radiated and high speed durability tends to deteriorate when a thickness of rubber in the vicinity of the belt end is high.

Accordingly, a pneumatic tire provided with a recessed groove extending along a tire circumferential direction in a buttress portion formed between a tread portion and a side-wall portion is disclosed in JP-A-2003-39917.

Moreover, a pneumatic tire having longitudinal holes provided in the tread portion at intervals in the tire circumferential direction and lateral holes provided in the buttress portion at intervals in the tire circumferential direction which are connected in respective groove bottoms is disclosed in JP-A-2014-133443.

Although the ground contact pressure in the vicinity of the ground contact end tends to be reduced from an outer side to an inner side in a tire width direction, it is difficult to control a reduction amount of the ground contact pressure in the tire width direction in the pneumatic tire disclosed in JP-A-2003-39917, therefore, it is difficult to sufficiently suppress uneven wear. As air tends to stay inside the recessed groove in this pneumatic tire, there is a possibility that heat generated at the belt end during travelling is not efficiently radiated.

In the pneumatic tire disclosed in JP-A-2014-133443, the longitudinal holes provided in the tread portion and the lateral holes provided in the buttress portion are connected in the groove bottoms, therefore, air in the longitudinal holes is pushed out to the lateral holes when the tread portion contacts a road surface. However, the longitudinal holes are connected to the lateral holes which have a longer length, therefore, the air pushed out from the longitudinal holes is not easily discharged from the lateral holes to the outside of the tire, and it is difficult to obtain sufficient heat radiation performance.

### SUMMARY OF THE INVENTION

In view of the above, an object of the present invention is to provide a pneumatic tire capable to efficiently radiate heat generated at the belt end during travelling while suppressing uneven wear occurring in the vicinity of the ground contact end of the tread portion.

A pneumatic tire includes a tread portion, a side wall portion, a buttress portion provided between the tread portion and the side wall portion, a recessed groove provided in the buttress portion and extending along a tire circumferential direction and small hole lines provided in a tire width direction inner side of a contact ground end in the tread portion, in which the small hole lines have a plurality of small holes provided at intervals along the tire circumferential direction, and the small holes communicate with the recessed groove.

### BRIEF DESCRIPTION OF THE DRAWINGS

FIG. 1 is a perspective view showing a half section of a pneumatic tire according to a first embodiment of the present invention;

FIG. 2 is a plan view of a tread portion of the pneumatic tire of FIG. 1;

FIG. 3 is an enlarged cross-sectional view of a relevant part of the pneumatic tire of FIG. 1;

FIG. 4 is an enlarged plan view of a relevant part of a tread portion of a pneumatic tire according to a second embodiment of the invention;

FIG. 5 is an enlarged plan view of a relevant part of a tread portion of a pneumatic tire according to a third embodiment of the invention; and

FIG. 6 is an enlarged plan view of a relevant part of the tread portion of the pneumatic tire according to the third embodiment of the invention.

### DESCRIPTION OF EMBODIMENTS

### First Embodiment

Hereinafter, a first embodiment of the present invention will be explained with reference to the drawings.

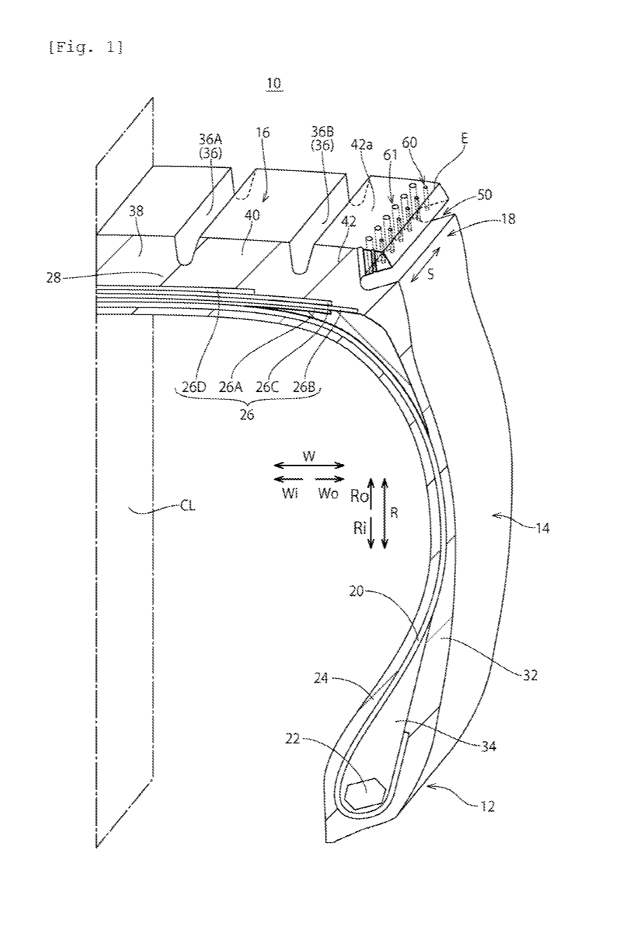

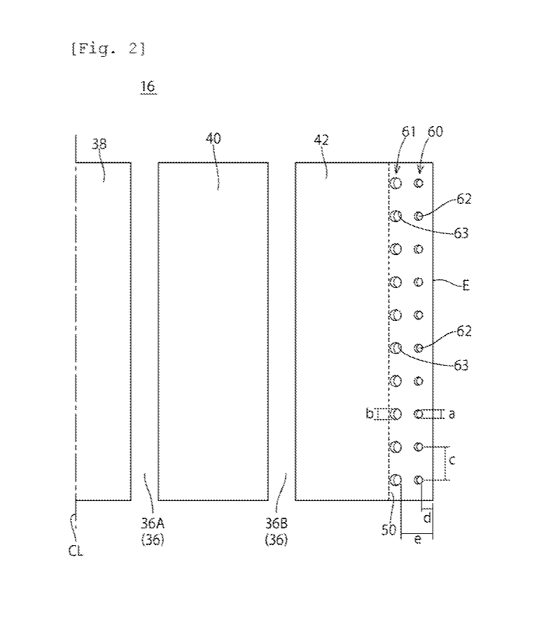

FIG. 1 is a perspective view showing a right-side half section of a pneumatic tire 10 according to the embodiment taken along a meridian portion including a tire axis. FIG. 2 is a plan view of a tread portion 16 of the pneumatic tire 10. As the pneumatic tire 10 is a symmetrical tire, a left-side half is not shown.

The pneumatic tire 10 shown in FIG. 1 and FIG. 2 includes a right and left pair of bead portions 12, a right and left pair of side wall portions 14 extending from the bead portions 12 outwardly in a radial direction, a tread portion 16 forming a tread surface and a right and left pair of buttress portions 18 arranged on a tire radial direction inner side of the tread portion 16. Here, the buttress portion 18 is a boundary region between the tread portion 16 and the side wall portion 14, which is provided so as to connect the tread portion 16 to the side wall portion 14.

The pneumatic tire 10 includes a carcass ply 20 provided to be stretched between the pair of bead portions 12 in a toroidal shape. In the pair of bead portions 12, ring-shaped bead cores 22 are respectively embedded.

The carcass ply 20 extends from the tread portion 16 to the bead portion 12 through the buttress portion 18 and the side wall portion 14 and locked by the bead core 22 at the bead portion 12, which reinforce the respective portions 12, 14, 16 and 18. The carcass ply 20 is locked by folding peripheral portions of the bead cores 22 from the inner side to the outer side in a tire width direction at both end portions. An inner liner 24 for holding air pressure is arranged on an inner side of the carcass ply 20.

The carcass ply 20 is formed of at least one ply formed by arranging an organic fiber cord so as to be inclined at a given angle (for example, 70° to 90°) with respect to a tire circumferential direction S and coated with topping rubber, and is formed by one ply in this example. As the cord for forming the carcass ply 20, for example, organic fiber cords made of polyester fiber, rayon fiber, aramid fiber, nylon fiber and the like are preferably used.

In the side wall portion 14, a side wall rubber 32 is provided on an outer side (namely, a tire outer surface side) of the carcass ply 20. In the bead portion 12, a bead filler 34 made of a hard rubber material extending toward a tire radial direction outer side in a tapered manner is arranged on an outer peripheral side of the bead core 22.

A belt 26 is arranged on the outer peripheral side of the carcass ply 20 in the tread portion 16. That is, the belt 26 is provided between the carcass ply 20 and a tread rubber 28 in the tread portion 16. The belt 26 is formed of plural pieces of cross belt plies arranged so that belt cords are inclined at a given angle (for example, 10° to 35°) with respect to the tire circumferential direction S. As the belt cord, a steel cord or an organic fiber cord having a high tensile force may be used.

The belt 26 has a four-layer structure in which a first belt 26A positioned on the innermost side in a tire radial direction inner side Ri, and second belt 26B, a third belt 26C and a fourth belt 26D laminated in order on the outer peripheral side thereof, in which the second belt 26B is the maximum width belt having the widest width.

On the surface of the tread portion 16, four main grooves 36 extending along the tire circumferential direction S are provided. Specifically, the main grooves 36 include a pair of center main grooves 36A arranged on both sides with a tire equatorial plane CL interposed therebetween, and a pair of shoulder main groove 36B provided on a tire width direction outer side Wo of the pair of center main grooves 36A. The tire width direction outer side Wo indicates a side away from the tire equatorial plane CL in a tire width direction W.

According to the above four main grooves 36, a central land portion 38 is formed between the two center main grooves 36A, intermediate land portions 40 are formed between the center main grooves 36A and the shoulder main grooves 36B and shoulder land portions 42 are formed on the tire width direction outer side Wo of the two shoulder main grooves 36B in the tread portion 16.

In this example, the central land portion 38, the intermediate land portions 40 and the shoulder land portions 42 are formed by ribs continued in the tire circumferential direction S. The central land portion 38, the intermediate land portions 40 and the shoulder land portions 42 may be a block line separated in the tire circumferential direction S by lateral grooves.

An outer end in the tire width direction of a tread surface 42a in the shoulder land portion 42 forms a tread ground contact end E. The buttress portion 18 extending inwardly in a tire radial direction and forming an upper part of a tire side surface is connected to the tread ground contact end E.

The pneumatic tire 10 according to the embodiment includes a recessed groove 50 opening to an outer surface of the buttress portion 18, a first small hole line 60 and a second small hole line 61 provided in the vicinity of the ground contact end E in the shoulder land portion 42.

In more detail, the recessed groove 50 is a recessed portion extending along the tire circumferential direction S. The recessed groove 50 is preferably provided in an annular shape continuously over the entire tire circumferential direction S. In the present embodiment, the recessed groove 50 is recessed in a direction inclined with respect to a direction perpendicular to the tire equatorial surface CL so as to be recessed toward the tire radial direction inner side Ri as coming close to a depth direction inner side. The recessed groove 50 has an almost constant groove width from an opening part to a bottom part of the buttress portion 18.

It is preferable that a depth direction of the recessed groove 50 is inclined at ±30° or less with respect to the direction perpendicular to the tire equatorial surface CL.

The first small-hole line 60 includes a plurality of first small holes 62 provided at intervals along the tire circumferential direction S. The plural first small holes 62 are hole portions with a circular shape in cross section which open to the tread surface 42a of the shoulder land portion 42, in which the inner side (tire radial direction inner side Ri side) communicates with the recessed groove 50. Then, the second small-hole line 61 is provided in a tire width direction inner side Wi of the tire small-hole line 60.

The second small-hole line 61 includes a plurality of second small holes 63 provided at intervals along the tire circumferential direction S. The plural second small holes 63 are hole portions with a circular shape in cross section which open to the tread surface 42a of the shoulder land portion 42, in which the inner side (tire radial direction inner side Ri side) communicates with the recessed groove 50.

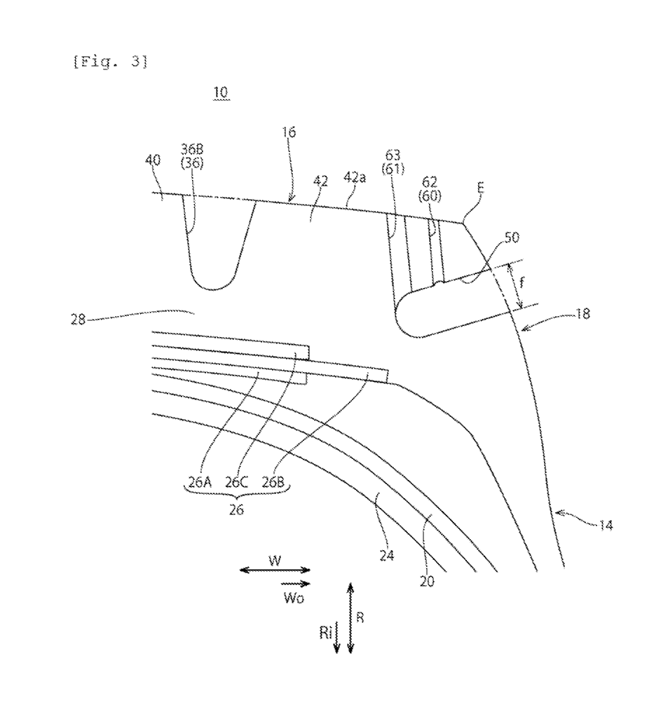

In the second small holes 63, a diameter “b” is larger than a diameter “a” of the first small holes 62, and an area of the second small holes 63 opening to the tread surface 42a of the shoulder land portion 42 (opening area) is larger than that of the first small holes 62. The diameter “a” of the first small holes 62 and the diameter “b” of the second small holes 63 are smaller than a width “f” (see FIG. 2 and FIG. 3) of the recessed groove 50 provided in the buttress portion 18.

In the present embodiment, the first small hole line 60 and the second small hole line 61 respectively have the same number of first small holes 62 and the second small holes 63, and the second small holes 63 are arranged on the tire width direction inner side Wi of the first small holes 62 so as to overlap with the first small holes 62 in the tire width direction W as shown in FIG. 3. That is, the first small holes 62 and the second small holes 63 are arranged in the same positions in the tire circumferential direction S.

Also in the present embodiment, the first small holes 62 and the second small holes 63 are provided in parallel one another, which are provided along a direction inclined with respect to a tire radial direction R so as to be inclined to the tire width direction outer side Wo as coming close to the depth direction inner side (recessed groove 50 side). In the present embodiment, an angle between the depth direction of the recessed groove and depth directions of the first mall holes 62 and the second small holes 63 make an acute angle (namely, less than 90 degrees).

Also in the embodiment, it is preferable that at least one of the small hole lines 60, 61 is provided on a groove bottom side of the recessed groove 50 (the tire width direction inner side Wi side from an intermediate point in the depth direction of the recessed groove), and the first small hole line 60 and the second small hole line 61 may be provided on the groove bottom side of the recessed groove 50.

Here, examples of respective dimensions of the recessed groove 50, the first small hole line 60 and the second small hole line 61 are cited with reference to FIG. 2 and FIG. 3. The width “f” of the recessed groove 50 may be set to 5 to 10 mm, the diameter “a” of the first small hole 62 may be set to 1.0 to 3.0 mm, the diameter “b” of the second small hole 63 may be set to 1.0 to 5.0 mm, an interval “c” of adjacent first small holes 62 (second small holes 63) in the tire circumferential direction S may be set to 2.0 to 20 mm, a distance “d” from an opening edge of the first small hole 62 formed in the tread surface 42a to the ground contact end E may be set to 3.0 to 10 mm and a distance “e” from an opening edge of the second small hole 63 formed in the tread surface 42a to the ground contact end E may be set to 7.0 to 20 mm.

The respective dimensions in the specification are in a normal state with no load in which the pneumatic tire is fitted to a normal rim and is filled with a normal internal pressure except for a case particularly mentioned. Also in the specification, the ground contact end indicates an end portion in the tire width direction on the tread surface contacting a road surface in a state where the pneumatic tire assembled to the normal rim and filled with the normal internal pressure is placed vertically on a flat road surface and a normal load is added.

The normal rim is a rim defined by respective standards for each tire in a standard system including standards to which the tire is conformed, which will be, for example, a standard rim in JATMA, “Design Rim” in TRA and “Measuring Rim” in ETRTO. The normal internal pressure is an air pressure defined by respective standards for each tire, in the standard system including standards to which the tire is conformed, which will be, for example, the maximum air pressure in JATMA, the maximum value written in a table “TIRE LOAD LIMITS AT VARIOUS COLD INFLATION PRESSURES” in TRA, and “INFLATION PRESSURE” in ETRTO, however, 180 kPA when the tire is for a passenger car. The normal load is a load defined by respective standards for each tire in a standard system including standards to which the tire is conformed, which will be, for example, the maximum load ability in JTAMA, the maximum value written in the above table in TRA, and “LOAD CAPACITY” in ETRTO, however, a load corresponding to 88% of the load when the tire is for the passenger car.

The pneumatic fire 10 according to the embodiment described above includes the recessed groove 50 provided in the buttress portion 18 along the tire circumferential direction S and the small hole lines 60, 61 including the plural small holes 62, 63 provided at intervals in the shoulder land portion 42 along the tire circumferential direction S.

Normally, in the pneumatic tire provided with the recessed groove in the buttress portion along the tire circumferential direction, the entire tread rubber portion on the tire radiation direction outer side of the recessed groove bends from the bottom portion of the recessed groove as a starting position when the tire contact the ground, therefore, a position corresponding to the bottom portion of the recessed groove hardly receives rigidicy reduction effect due to the recessed groove and a reduction amount of rigidity tends to be short. However, the pneumatic tire 10 according to the embodiment includes the small hole lines 60, 61 having the plural small holes 62, 63 provided at intervals in the shoulder land portion 42 along the tire circumferential direction S, in addition to the recessed groove 50, therefore, rigidity in the position corresponding to the bottom surface of the recessed groove 50 can be easily adjusted. Accordingly, the reduction amount of rigidity in the vicinity of the ground contact end E of the shoulder land portion 42 can be gradually reduced from the tire width direction outer side Wo to the tire width direction inner side Wi, therefore, uneven wear occurring in the vicinity of the ground contact end E can be effectively suppressed.

The pneumatic tire 10 according to the embodiment also includes the plural small hole lines 60, 61 at an interval in the tire width direction W, therefore, the rigidity in the shoulder land portion 42 can be easily controlled in the tire width direction W, which can suppress uneven wear occurring in the vicinity of the ground contact end E further effectively.

Additionally, the pneumatic tire 10 according to the embodiment can adjust the rigidity of the shoulder land portion 42 in the tire width direction W by setting the opening area with respect to the tread surface 42a in the shoulder land portion 42 to be larger in the second small holes 63 than in the first small holes 62, thereby effectively suppressing uneven wear occurring in the vicinity of the ground contact end E in a simple manner.

Also in the pneumatic tire 10 according to the embodiment, the first small holes 62 and the second small holes 63 opening to the tread surface 42a in the shoulder land portion 42 communicate with the recessed groove 50 opening to the buttress portion 18. Accordingly, when the tread surface 42a contacts the road surface and the shoulder land portion 42 is compressed and deformed, air in the first small holes 62 and the second small holes 63 is pushed out and discharged to the recessed groove 50. As the recessed groove 50 is provided along the tire circumferential direction S, air pushed out from the first small holes 62 or the second small holes 63 at the time of contacting the ground is diffused in the tire circumferential direction S inside the recessed groove 50.

Then, the tread surface 42a is separated from the road surface and the shoulder land portion 42 is returned to the original state by an elastic force, the first small holes 62 and the second small holes 63 take the air from openings provided on the tread surface 42a or connecting portions with respect to the recessed groove 50. At that time, the air pushed out from the first small holes 62 and the second small holes 63 at the time of contacting the ground is diffused into the recessed groove 50, therefore, the air is not taken into the first small holes 62 and the second small holes 63 again, and heat generated at the belt end during travelling can be radiated efficiently.

### Second Embodiment

Next, a second embodiment of the present invention will be explained. Explanation for the same parts as those of the first embodiment is omitted and different parts will be explained.

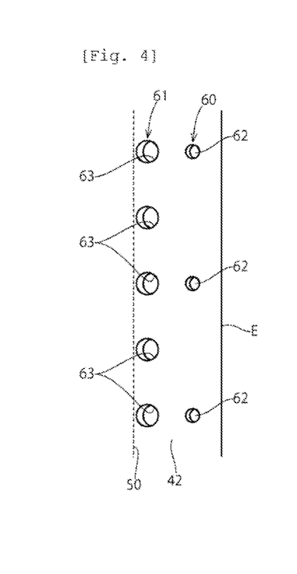

In the above embodiment, the number of the first small holes 62 forming the first small line 60 and the number of the second small holes 63 forming the second small hole line 61 are the same, however, the number of the second small holes 63 forming the second small hole line 61 may be larger than the number of the first small holes 62 forming the small hole line 60, for example, as shown in FIG. 4.

The number of the first small holes 62 is set to be different from the number of the second small holes 63 as described above, thereby adjusting the rigidity of the shoulder land portion 42 in the tire width direction W and effectively suppressing uneven wear occurring in the vicinity of the ground contact end E in a simple manner.

Other structures and operational effects are the same as those of the first embodiment and detailed explanation is omitted.

### Third Embodiment

Next, a third embodiment of the present invention will be explained. Explanation for the same parts as those of the first embodiment is omitted and different parts will be explained.

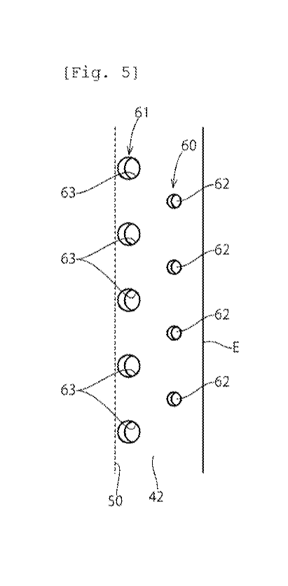

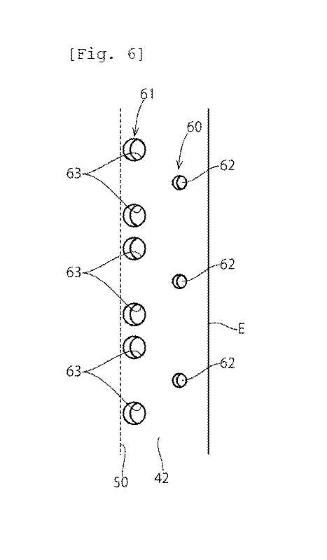

In the above embodiment, the first small holes 62 forming the first small hole line 60 and the second small holes 63 forming the second small hole line 61 are provided in the same positions in the tire circumferential direction S, however, for example, it is preferable that the first small holes 62 and the second small holes 63 are arranged alternately in zigzag and the number of the first small holes 62 is set to be the same as the number of the second small holes 63 as shown in FIG. 5. It is also preferable that the first small holes 62 and the second small holes 63 are provided at positions shifted from one another in the tire circumferential direction and that the number of the second small holes 63 is set to be larger than the number of the first small holes 62 as shown in FIG. 6.

In the present embodiment, the rigidity of the shoulder land portion 42 can be adjusted in the tire width direction W by changing positions of the first small holes 62 and the second small holes 63 in the tire circumferential direction S, as a result, uneven wear occurring in the vicinity of the ground contact end E can be effectively suppressed in the simple manner.

Other structures and operational effects are the same as those of the first embodiment and detailed explanation is omitted.

### MODIFICATION EXAMPLES

The above embodiments are cited as examples and are not intended to limit the scope of the invention. The novel embodiments may be achieved in other various manners, and various kinds of omission, replacement and alterations may occur within a scope not departing from the gist of the invention.

For example, the example in which the two small hole lines 60, 61 are provided in the tire width direction inner side Wi of the ground contact end E has been explained in the above embodiments, however, one small hole line or three or more small hole lines may be provided in the tire width direction inner side Wi of the ground contact end E. When the three or more small hole lines are provided, small holes forming a small hole line positioned closer to the tire width direction outer side may be formed to have a smaller opening area with respect to the tread surface 42a, or the number of small holes forming the small hole line may be reduced in a small hole line positioned closer to the tire width direction outer side.

Moreover, the example in which the diameter “b” of the second small holes 63 is larger than the diameter “a” of the first small holes 62 has been explained in the above embodiments, however, the diameter “b” of the second small holes 63 may be the same as the diameter “a” of the first small holes 62 or the diameter “b” of the second small holes 63 may be smaller than the diameter “a” of the first small holes 62 in the present invention.

Furthermore, the number of the second small holes 63 may be larger than the number of the first small holes 62 as well as smaller than the number of the first small holes 62.

What is claimed is:

1. A pneumatic tire comprising:
a tread portion;
a side wall portion;
a buttress portion provided between the tread portion and the side wall portion;
a recessed groove provided in the buttress portion and extending along a tire circumferential direction; and
small hole lines provided in a tire width direction inner side of a contact ground end in the tread portion,
wherein the small hole lines have a plurality of small holes provided at intervals along the tire circumferential direction, and
the small holes communicate with the recessed groove.

2. The pneumatic tire according to claim 1,
wherein the small hole lines include a first small hole line and a second small hole line provided at an interval in the tire width direction inner side of the first small hole line,
the first small hole line has a plurality of first small holes provided at intervals along the tire circumferential direction, and
the second small hole line has a plurality of the second small second holes provided at intervals along the tire circumferential direction.

3. The pneumatic tire according to claim 2,
wherein the first small holes have a smaller opening area with respect to the tread portion than the second small holes.

4. The pneumatic tire according to claim 2,
wherein the number of the first small holes forming the first small hole line is smaller than the number of the second small holes forming the second small hole line.

5. The pneumatic tire according to claim 2,
wherein the first small holes and the second small holes are provided at positions shifted one another in a tire width direction.

6. The pneumatic tire according to claim 2,
wherein a depth direction of the first small holes and a depth direction of the second small holes are parallel to each other.

7. The pneumatic tire according to claim 1,
wherein the recessed groove is recessed in a direction inclined with respect to a direction perpendicular to a tire equatorial surface so as to be recessed toward a tire radial direction inner side as coming close to a depth direction inner side.

8. The pneumatic tire according to claim 1,
wherein the small holes are recessed in a direction inclined with respect to a tire radial direction so as to be recessed toward a tire width direction outer side as coming close to a depth direction inner side.

9. The pneumatic tire according to claim 1,
wherein an angle made by the depth direction of the recessed groove and the depth directions of the small holes is an acute angle.
